(19) United States
(12) Patent Application Publication
(10) Pub. No.: US 2009/0160735 A1
(43) Pub. Date: Jun. 25, 2009

(54) SYSTEM AND METHOD FOR DISTRIBUTING CONTENT TO A DISPLAY DEVICE

(76) Inventor: Kevin James Mack, Palo Alto, CA (US)

Correspondence Address: KEVIN J. MACK, 112 MAPLE LN, E. PALO ALTO, CA, 94303, US

(21) Appl. No.: 11/960,682

(22) Filed: Dec. 19, 2007

(51) Int. Cl. H04L 12/28

(52) U.S. Cl. 345/2.3

(57) ABSTRACT

A system and method for distributing content to a display device is disclosed. In some embodiments, the display device comprises a processor that decodes visual content, a wireless interface that communicates with a wireless device associated with a viewer of the display device, and logic configured to receive information from the wireless device and purchase an item depicted on the display device for the viewer. In other embodiments, the method comprises receiving a request to broadcast content based, at least in part, on one or more variable metrics, monitoring a plurality of data sources that contain information related to the one or more variable metrics, and distributing the content to locations satisfying a relation utilizing the one or more variable metrics.

### FIELD OF THE INVENTION

The invention relates generally to a display device and, more particularly, to a system and method for distributing content to a display device.

### BACKGROUND

Billboards, signs, newspapers, posters, and flyers are conventional mediums for conveying information to the public. The information conveyed with these conventional mediums generally comprises static content, such as print advertisements, still images, and other fixed promotional material. Public and private corporations, government agencies, and individuals who desire to place content on these conventional mediums carefully select which medium to utilize based, at least in part, on the medium's characteristics, such as location, reach, and cost. For example, a corporation desiring to promote a high-end product to wealthy urbanities may select a billboard located in an affluent part of a major city. Likewise, an individual attempting to garner votes in a local election may canvass his relevant voting district with flyers and posters.

Unfortunately, conventional mediums for conveying information suffer from several shortcomings. First, conventional mediums are relatively expensive to widely deploy. For example, printing and distributing thousands of flyers is a time consuming and costly endeavor. Second, the static content placed on conventional mediums is incapable of being updated after dissemination. Thus, conventional mediums are not well suited for conveying dynamic information. Third, the location or placement of a conventional medium will generally determine its effectiveness. If adequate placement is not available, conventional mediums may not be pragmatic. Fourth, conventional mediums are difficult to tailor to specific physical regions and intended viewer segments. For example, several versions of an advertisement are typically needed for a global advertising campaign. Each version of the advertisement needs to be tailored to the region in which the advertisement will be disseminated, for example, by rendering the advertisement in the native language of each region. Lastly, conventional mediums do not allow viewer interaction. For example, if a viewer sees a product or service that the viewer desires to purchase, the viewer must purchase the product by calling a phone number or visiting a web site, instead of a more direct and interactive means of purchasing the item. Thus, what is needed is a system and accompanying method that alleviates some or all of these shortcomings.

### BRIEF SUMMARY

A system and method for distributing content to a display device is disclosed. In some embodiments, the display device comprises a processor that decodes visual content, a wireless interface that communicates with a wireless device associated with a viewer of the display device, and logic configured to receive information from the wireless device and purchase an item depicted on the display device for the viewer. In other embodiments, the method comprises receiving a request to broadcast content based, at least in part, on one or more variable metrics, monitoring a plurality of data sources that contain information related to the one or more variable metrics, and distributing the content to locations satisfying a relation utilizing the one or more variable metrics.

### BRIEF DESCRIPTION OF THE DRAWINGS

For a detailed description of exemplary embodiments of the invention, reference will now be made to the accompanying drawings in which:

FIG. 1 illustrates an exemplary system constructed in accordance with embodiments of the invention;

FIG. 2 depicts the display device of FIG. 1 in greater detail;

FIG. 3 illustrates an exemplary network constructed in accordance with embodiments of the invention;

FIG. 4 depicts an exemplary display system constructed in accordance with embodiments of the invention;

FIG. 5 illustrates a flow chart of an exemplary method for displaying personalized content on a display device in accordance with embodiments of the invention;

FIG. 6 depicts a flow chart of an exemplary method for wirelessly connecting a user to a display device in accordance with embodiments of the invention;

FIG. 7 illustrates a flow chart of an exemplary method for trading and auctioning spots on a network of display devices;

FIG. 8 depicts an exemplary visualization system for viewing and publishing content to a network of display devices;

FIG. 9 illustrates a flow chart of an exemplary method for scheduling and broadcasting content to a network of display devices; and

FIG. 10 depicts a method for distributing content to a display in accordance with embodiments of the invention.

### NOTATION AND NOMENCLATURE

In the following discussion and in the claims, the terms “including” and “comprising” are used in an open-ended fashion, and thus should be interpreted to mean “including, but not limited to”. Also, the term “couple, “couples,” or “coupled” is intended to mean either an indirect or direct electrical or communicative connection. Thus, if a first device couples to a second device, that connection may be through a direct connection, or through an indirect connection via other devices and connections.

### DETAILED DESCRIPTION

In this disclosure, numerous specific details are set forth to provide a sufficient understanding of the present invention. Those skilled in the art, however, will appreciate that the present invention may be practiced without such specific details. In other instances, well-known elements have been illustrated in schematic or block diagram form in order not to obscure the present invention in unnecessary detail. Additionally, some details have been omitted inasmuch as such details are not considered necessary to obtain a complete understanding of the present invention, and are considered to be within the understanding of persons of ordinary skill in the relevant art. It is further noted that all functions described herein may be performed in either hardware or software, or a combination thereof, unless indicated otherwise. Moreover, certain terms are used throughout the following description and claims to refer to particular system components. As one skilled in the art will appreciate, components may be referred to by different names. This document does not intend to distinguish between components that differ in name but not function.

The following discussion is also directed to various embodiments of the invention. Although one or more of these embodiments may be preferred, the embodiments disclosed should not be interpreted, or otherwise used, as limiting the scope of the disclosure, including the claims, unless otherwise specified. In addition, one skilled in the art will understand that the following description has broad application, and the discussion of any embodiment is meant only to be illustrative of that embodiment, and not intended to suggest that the scope of the disclosure, including the claims, is limited to that embodiment.

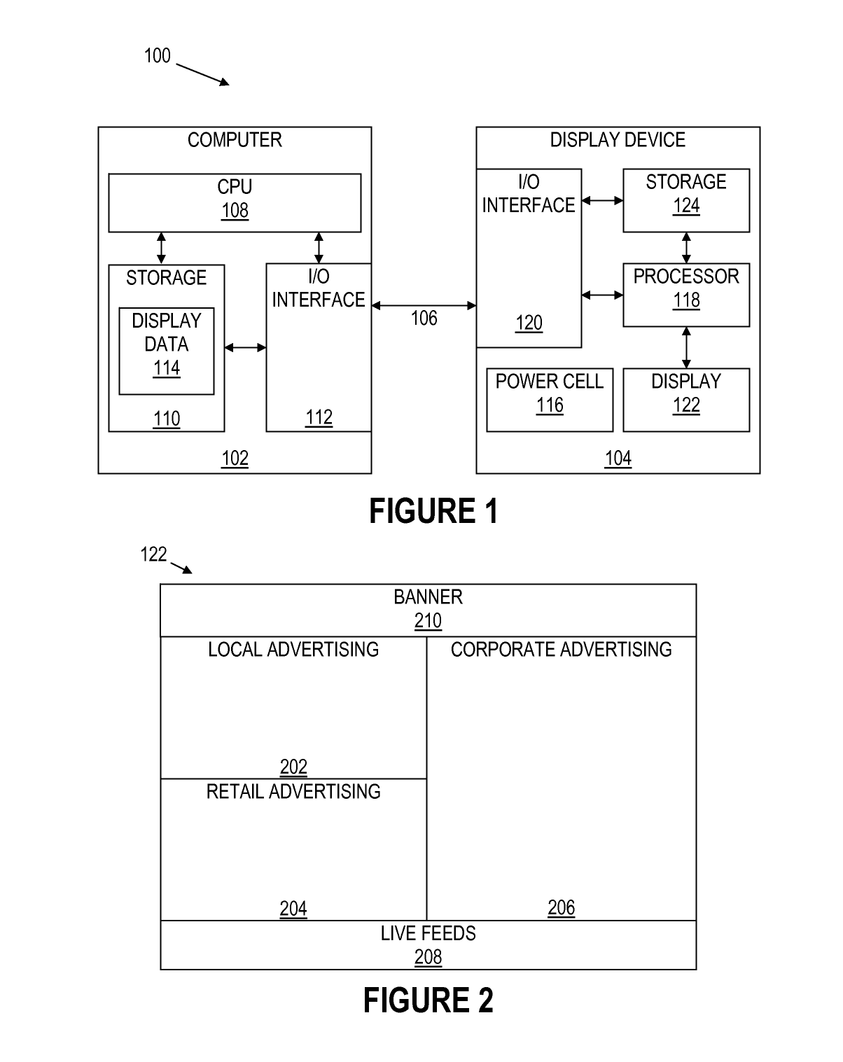

FIG. 1 illustrates a system 100 constructed in accordance with embodiments of the invention. System 100 comprises a computer 102 coupled to a display device 104 by a communications channel 106. The computer 102 may be any type of computer system, such as a laptop computer, a personal computer, or a stand-alone computer operated as a server. As illustrated in FIG. 1, the computer 102 comprises a central processing unit (CPU) 108, a storage 110, and an Input/Output (I/O) interface 112. The computer 102 may comprise a single CPU 108 or may comprise a plurality of CPUs arranged in a configuration where parallel computing may take place. The CPU 108 couples to the storage 110 which stores display data 114. The storage 110 may represent any type of volatile and/or non-volatile memory, such as random access memory (RAM) and read only memory (ROM), or any other medium for storing information, such as a hard drive, universal serial bus (USB) flash drive, memory stick, cell phone, and iPod®. The display data 114 may represent any type of static, semi-static, or dynamic content, such as still images and text, motion pictures, animated graphics, and video. The storage 110 couples to the I/O interface 112 which transmits the display data 114 through the communications channel 106 to the display device 104.

As illustrated in FIG. 1, the display device 104 comprises a power cell 116, a processor 118, an I/O interface 120, a display 122, and a storage 124. The display data 114 may be transferred from the computer 102 to the display device 104 via the communications channel 106 and the I/O interfaces 112 and 120. The I/O interfaces 112 and 120 may represent any communications interface adapted to send and receive data via the communication channel 106. Such communication interfaces may include a Wi-Fi, Wi-Max, cellular, pager, or satellite transceiver, a USB interface for, a FireWire interface, or any other type of communications interface capable of receiving data through the communications channel 106, such as an interface adaptor for an ipod®. The display device 104 may represent a small form factor PC, such as a Mac Mini from Apple Inc. and a miniPC from Aopen Inc., coupled to a traditional flat screen display, such as an LCD monitor, an LCD television, a plasma monitor, and a plasma television.

The communications channel 106 represents any type of wireless and/or wire line communications channel that facilitates the transfer of the display data 114 from the computer 102 to the display device 104. Depending upon the data rate desired, various wireless and wire line technologies may be employed. For example, in wireless embodiments, the communication channel 106 may employ a communications protocol or standard, such as Wi-Fi (i.e., Institute of Electrical and Electronics Engineers (IEEE) 802.11 and its variants), Global System for Mobile communication (GSM), Code-Division Multiple Access (CDMA) and its variants (e.g., Wideband CDMA (W-CDMA), Broadband CDMA (B-CDMA), Time Division CDMA (TD-CDMA), and CDMA2000), Orthogonal Frequency Division Multiplexing (OFDM) and it variants, General Packet Radio Service (GPRS), Enhanced Data rates for GSM Evolution (EDGE), any other second (2G), third (3G), or fourth (4G) mobile technology, Bluetooth, and Infrared (IrDA). Paging technologies, such as Post Office Code Standardization Advisory Group (POCSAG), FLEX, ReFLEX, and InFLEXion may also be used as desired. In some wire line embodiments, a keyboard or other input device may be connected to the display device 104 to create and transfer the display data 114. In these wire line embodiments, the computer 102 is optional and the keyboard or other input device creates and facilitates the transfer of the display data 114 to the display device 104.

The processor 118 preferably includes a clock or oscillator that provides timing for the components of the display device 104. In at least some embodiments, the timing for the display device 104 is provided by a phase-locked-loop (PLL) circuit. The processor 118 may process, decode, convert, modify, arrange, and/or transform the display data 114. For example, the display data 114 is preferably encoded with a file or video format, such as PNG, GIF, BMP, JPEG, AVI, MPEG, and Flash. The processor 118 may therefore decode the file or video format in order to display the display data 114 on the display 122. In addition, the processor 118 may perform others functions related to the operation of the display 122, such as control when the display 122 turns off, sleeps, or enters a standby state. The processor 118 may represent any type of software and/or hardware that is capable of processing the display data 114, such as Intel's PXA27x family of microprocessors, Texas Instruments' TCS3500 chip set, Intel's Core Duo processor, a field programmable gate array (FPGA), and a PCI, PCI Express, and an AGP graphics controller. Moreover, the processor 118 may be designed with any suitable architecture, such as IA-32, IA-64, AMD64, AMD K8, EM64T, and RISC, and may run any suitable operating system, such as Unix based operating systems, Mac OS X, Windows, VxWorks, eCos, and Palm OS.

The storage 124 couples to the I/O interface 120 and stores content that is to be displayed on the display 122. The storage 124 may comprise any type of volatile memory and/or non-volatile memory, such as random access memory (RAM) and read only memory (ROM), or any other medium for storing information, such as a hard drive, Universal Serial Bus (USB) Flash drive, memory stick, cell phone, and an iPoD®. In some embodiments, the storage 124 contains preconfigured data and functions, such as compression/decompression algorithms, priority display functions, audio/video codecs, audio visualization functions, text translation functions, music lyric lookup functions, and closed caption lookup functions. The processor 118 may utilize the preconfigured data and functions to perform tasks associated with the operation of the display device 104. For example, the processor 118 may utilize a text translation function stored in the storage 124 to translate display data from one language to another before being displayed on the display 122. Another example includes the automated lookup of song lyrics. In this example, once an audio device, such as an ipod®, is coupled to the display device 104 via the I/O interface 120, the processor 118 may execute the audio visualizations and lyric lookup functions for a particular song to display audio visualizations and the lyrics of the song on the display 122. Similarly, a closed caption decoder may be stored in the storage 124 to provide the capability to display captions for visual content, such as movies, movie pictures, animations, and commercial advertisements.

Priority display functions may also be stored in the storage 124 to control the type of content displayed on the display 122. For example, a priority display function may determine when the display device 104 displays user-created content and when advertisements are displayed. As can be appreciated, such priority functions may control the type of content that is displayed on the display 122, thereby facilitating various types of advertising business models. For example, one business model may permit advertisements to be displayed on the display 122 a configurable percentage of the time that the display device 104 is active and operational. Under this exemplary business model, a user would only be able to display user-created content during times when advertisements were not being displayed, thereby creating a priority scheme for the various types of content. If the user attempts to display lower priority, user-created content while the priority function has locked out the user, the user's content may optionally be queued for display after the advertisements have been displayed. In these queuing based embodiments, the lower priority content is preferably stored in the storage 124.

In some embodiments, the preconfigured data and functions, as well as the data to be displayed, may be stored external to the display device 104, for example, on a server coupled to the display device 104 via the Internet. In these embodiments, the display device 104 sends a request with data to the external source and receives a reply containing the data after it has been processed by the function indicated in the request.

In other embodiments, the communications channel 106 represents the physical transportation of data by a physical storage device, such as the transfer of data from the computer 102 to the display device 104 via a USB flash drive. In these embodiments, a user physically connects a storage device containing the display data 114 to the display device 104. The display device 104 detects the connection of the storage device, accesses the data stored on the storage device, and displays this data on the display 122 after being optionally processed and formatted by the processor 118.

The display device 104 may optionally include a global position locator to be used in conjunction with a global position system (GPS). The global position locator allows the physical location of the display device 104 to be determined. The global position locator may be powered by the power cell 116 and may optionally utilize components of the I/O interface 120 to transmit its GPS signal. The display device 104 may also optionally include a motion detector or a camera. The motion detector or camera may detect when an object or person is near the display device 104. For example, the motion detector may be configured to count the number of people passing by the display device and report this information to a central server either periodically or in real-time. Similarly, the display device 104 may enter into a low power state when the motion detector or camera does not detect passers-by. As can be appreciated by one of skill in the art, virtually any type of peripheral, such as microphones, barcode readers, tachometers, visible light sensors, and heat sensors, may be coupled to the display device 104 to increase the functionality of the system 100.

For example, the system 100 may be integrated with a retailer's inventory management system through a barcode reader. When a customer purchases an item, a cashier may scan the item's barcode with the barcode reader. The barcode reader may then convert the barcode to an identifier uniquely representing the item purchased by the customer. The inventory management system may process the information generated by the barcode reader to maintain an accurate listing of products and available quantity at the retailer's establishment. The inventory management system may also control the content depicted on the display 122. For example, the inventory management system may contain data indicating that a convenience store sells a lot of soda during the summer. The convenience store's inventory management system may be integrated with the system 100 and trigger the display 122 to show ads for soda when customers start purchasing soda (e.g., just before or during the summer). Thus, the inventory management system may control, at least in part, the content displayed on the display 122 based on the purchasing habits of customers. Such a system may be implemented with logic coupled to, or integrated with, the inventory management system. The logic may be implemented with software, hardware, or a combination thereof.

In some embodiments, the power cell 116 is coupled to a timer which detects the time that has elapsed since a predetermined condition has occurred. Such conditions may comprise the last time content was displayed on the display 122, the last time an active wireless connection was established by the I/O interface 120, or any other event detectable by the timer. After the timer is initialized and a predetermined time has elapsed from the occurrence of a condition, the display device 104 may enter into a power saving mode, in which non-critical circuitry is either powered off or set to a reduced power state. As can be appreciated, such embodiments preserve the energy stored in the power cell 116, thereby increasing the amount of time that the power cell 116 may power the display device 104.

The power cell 116 may produce energy to either fully or partially power the display device 104. The power cell 116 may comprise alkaline, nickel-cadmium (NiCd), any other type of battery, or an AC or DC power source. In at least some embodiments, renewable energy source, such as kinetic or solar power, are employed to power the display device 104. For example, solar power cells or panels may be employed to fully or partially power the display device 104. In at least some embodiments, the power cell 116 is used in conjunction with a secondary power source, such as a car battery, to power the display device 104. The power cell may also represent an uninterruptible power supply (UPS) that is configured to supply power to the display device 104 and/or the computer 102. In these embodiments, the UPS prevents the system 100 from losing power and turning off. Preferably the UPS also had a data connection with the system 100 that initiates a change in power state of the system 100. For example, when a power surge, spike, or brownout is detected by the UPS, a signal is sent to the system 100 that triggers a reduced power state in one or more of the components of system 100. This reduced power state may comprise a full or partial system shutdown or an operating mode that consumes less power, such as putting the computer 102 into standby or hibernation mode. When the power resumes to normal operating levels, the computer 102 may automatically resume from standby or move out of hibernation mode. Thus, the UPS increases the uptime of the system 100 by automating power distribution under non-ideal operating conditions, such as blackouts and brownouts. In at least some embodiments, the computer 102 and the display device 104 are integrated into a single unit.

FIG. 2 shows the display 122 in more detail. The display 122 may represent an LCD display, a plasma display, a grid of light emitting diodes (LEDs), or any other means of displaying content, such as photosensors, electronic ink, organic light-emitting diodes (OLEDs), transparent OLEDs, and solid state lighting (SSL) LEDs. LEDs are semiconductor devices that emit light when electrically biased in the forward direction. The color of the emitted light depends on the chemical composition of the semiconducting material used, and can be near-ultraviolet, visible or infrared. In at least some embodiments, the display is a high definition monitor operating at a resolution of 1080i/p, i.e., 1920×1080 at 50-60 Hz frame rate, HDTV 1440 p, UHDV 2540 p, or UHDV 4320 p. In whichever resolution selected, the display 122 may be positioned in either a landscape or portrait orientation as desired.

As shown in FIG. 2, the display 122 is preferably segmented into a plurality of sections 202-210. Each section comprises a defined type of media content. For example, section 202 may comprise local advertising, section 204 may comprise retail advertising, section 206 may comprise corporate advertising, section 208 may comprise live information feeds, and section 210 may comprise an informational banner. The feeds may utilize standards, such as Really Simple Syndication (RSS 2.0), Rich Site Summary (RSS 0.91, RSS 1.0), RDF Site Summary (RSS 0.9 and 1.0), or any other means for aggregating content, such as GeoRSS. Each segment is preferably implemented as a frame of a webpage written in dynamic HTML or any language suitable for displaying static and/or dynamic content. This content may comprise full motion video, animation, news, weather, sport scores, blogs, wikis, or any other type of information that may be conveyed on the display 122, such as geo-tagged images. Section 210 preferably cycles the name and address of the establishment where the display 122 is physically located along with the establishment's hours of operations and any other configurable information associated with the establishment. Although shown in FIG. 2 as segmented into four sections 202-208, the display 122 may comprise any number of sections depending upon the desired configuration of the display. The size and location of each section may also be modified as desired.

Each section 202-210 preferably cycles a queue of content. For example, section 202 may cycle through a queue of twenty advertisements, each advertisement comprising static and/or dynamic content, such as images, videos, blogs, websites, HTML, RSS, and GeoRSS feeds. The content in the queue may be displayed for an associated duration of time. For example, a first advertisement in a queue may be displayed for fifteen seconds and a second advertisement in the queue may be displayed for thirty seconds. The duration of time each advertisement is displayed may be determined in advance of a user placing the content in the queue or preferably dynamically when the advertisement is displayed. For example, when displaying the first advertisement in the queue, software may dynamically detect that the first advertisement has a duration of fifteen seconds, and correspondingly display this advertisement for this period of time. This detection may be accomplished by reading the header of the file containing the advertisement and extracting the length or duration of the file. After the first advertisement is displayed, the second advertisement in the queue is displayed. Again, the duration of this second advertisement may be dynamically determined and displayed for the determined time. In essence, these embodiments generate a dynamic “playlist” of content to be cycled on a display.

In at least some embodiments, the display device 104 displays television content in one or more screen sections and web-based advertising content in at least one other section. The television content may comprise both analog and digital standard-definition, enhanced definition, and high-definition television, such as NTSC, ATSC, DVB-T, ISDB-T, PAL, PAL2, SECAM, operating in any desired resolution, such as 480 p, 576 p, 720 p, 1080 i, and 1080 p, and any desired frame rate. The web-based advertising content is preferably delivered via the Internet, or via a cable or satellite, and focused based on a viewer's interaction with the display device 104. For example, if a viewer of the display device repeatedly watches sporting events on the television section, the advertisements displayed in the advertising section may be associated sports to increase their relevancy to the user. In addition, the display device may focus advertisements and other content based on analytics known about the viewer. Logic within the display device monitors the user's interaction with the display device and determines which advertisements to show in which section at any given time. Such interaction may include the frequency of use, the viewer's favorite channels, the amount of time on a particular channel, and any other metric capable of being ascertained by the logic. As can be appreciated, such advertising provides a more tailored experience for the viewer and increases the value of the advertising. In some embodiments, the television content is commercial free because the web-based advertising section replaces the need for commercials in the television section. As can be appreciated by those skilled in the art, such embodiments provide a platform for focused, web-based advertising during television viewing. The television content may be either streamed from the Internet or derived from tradition or digital television signals via a tuner embedded with, or coupled to, the display device.

The display device 104 also preferably pre-fetches and caches the content identified on the playlist before its scheduled display time to ensure that the content is displayed smoothly without the need to stream the content from remote sources. By pre-fetching and caching the content in advance, the quality of display is not affected by remote factors, such as a slow Internet connection or network inefficiencies. In some embodiments, the playlist may be built using the physical location of the display. For example, content that has geomarkers, or any other type of metadata that signifies location, may be automatically inserted in the playlist for a display that is in physical proximity to the location identified by the geomarkers. Thus, the content displayed on each display may be particularized and focused for the region surrounding each display. When a user desires to broadcast content onto a display, metadata associated with the content may be examined to determine which queues and playlist to place the content. Such automatic extraction of semantics helps increase the relevancy of the content on the display. Although place semantics were used in the above example, other types of semantics, such as time, may similarly be used. Thus, the metadata may facilitate what content is displayed on which display device at any given time.

In at least some embodiments, the display 122 is positioned inside of a storefront window so as to permit viewers outside of the store to view the display. Generally, such viewers comprise pedestrians and/or vehicular traffic. The content on the display 122 may direct attention to a business, commodity, industry or other activity which is sold, offered or conducted elsewhere than on the premises upon which the display is located. For example, the display 122 may be installed in the storefront window of a convenience store and display promotions for a law firm, even though the convenience store is not associated, or otherwise affiliated, with the law firm. In these embodiments, the display 122 be affixed to the storefront window, or preferably, positioned as a window display not directly affixed to the window but placed near the window so as to be visible from outside of the store.

In some mobile embodiments, the display 122 is attached to the inside of a vehicle's translucent window. For example, the display 122 may be attached to the inside rear window of a vehicle, such as a truck, van, car, bus, taxi, train, airplane, and military vehicle. Fasteners may allow for the display 122 to be positioned in various angles, depending upon the desired viewing angle for the intended audience of the display 122. In still other embodiments, the display 122 is positioned inside a building for persons in the building to view. In these embodiments, the display 122 is positioned in places where people tend to congregate, such as near the cash register, throughout the check-out line, in or around the bathroom, or near popular products. In at least some embodiments, the display 122 is positioned outside in a configuration similar to traditional billboards.

As can be appreciated by one skilled in the art, the foregoing discussion is directed to the design associated with a display system. Various additional components of the system 100, such as servers, databases, and software applications, may be utilized to implement each of the components of the computer 102 and the display device 104. Moreover, many of the components of the system 100 may be implemented in either hardware, software, or a combination thereof. This disclosure is intended to encompass all such variations.

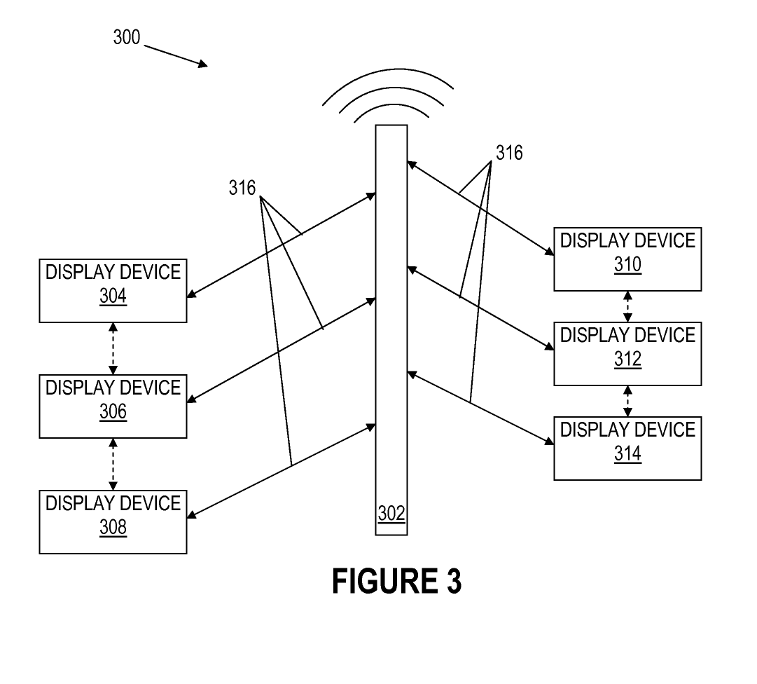

FIG. 3 illustrates an exemplary network 300 in accordance with embodiments of the invention. The network 300 comprises one or more transmission towers 302 and a plurality of display devices 304-314. The display devices 304 are coupled to the transmission tower 302 via transmission channels 316. The transmission tower 302 may be representative of a cellular tower, or any other transmission medium, such as a Wi-Fi access point or a pager tower. As shown in FIG. 3, the display devices 304-314 may optionally be coupled together via communications channels to facilitate the transfer of data among the display devices 304-314, thereby creating a network of interlinked display devices. Each display device 304-314 may represent a client of the network 300. In some embodiments that employ Wi-Fi technology to connect the display devices to the Internet via Transmission Control Protocol/Internet Protocol (TCP/IP), each display device 304-314 may be assigned a unique IP address.

Although six display devices are illustrated in FIG. 3, any number of display devices may be connected to the network 300. Once a network of display devices is established, content may be selectively displayed on the networked display devices. For example, an advertiser may desire to display a particular advertisement in a particular region. After the advertiser selects a region, the advertisement may be sent only to the display devices located in the desired region. The current location of the display device may be determined in a number of ways. For example, the location may be inferred from the display device's IP address or determined from a GPS locator embedded in the display device. Alternatively, the display device may be installed in a fixed, known location, such as in the window of a building.

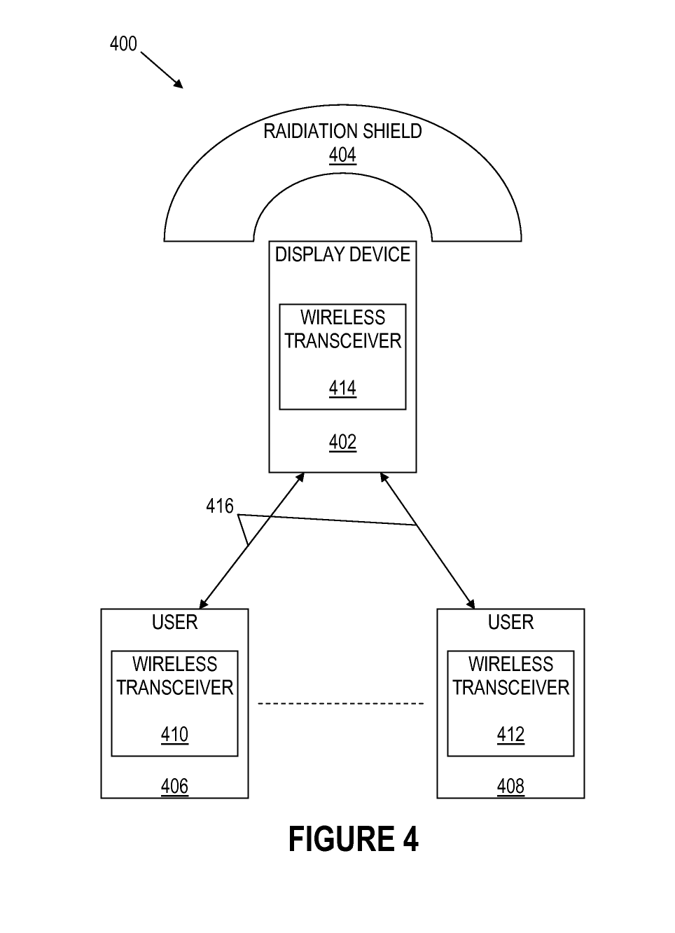

FIG. 4 illustrates an exemplary display system 400 in accordance with embodiments of the invention. The display system 400 comprises a display device 402, a radiation shield 404 and one or more users 406-408. Each user 406-408 preferably possesses a wireless transceiver 410-412 that transmits data to a wireless transceiver 414 coupled to the display device 402 via one or more wireless communication links 416. For example, each user 406-408 may carry a communications device, such as cellular phone, PDA, or pocket PC, with the wireless transceivers 410-412 embedded therein.

The wireless communication links 416 may comprise any type of wireless data link, such as Wi-Fi (i.e., Institute of Electrical and Electronics Engineers (IEEE) 802.11 and its variants), WiMAX (i.e., 801.16 and its variants), Global System for Mobile communication (GSM), Code-Division Multiple Access (CDMA) and its variants (e.g., Wideband CDMA (W-CDMA), Broadband CDMA (B-CDMA), Time Division CDMA (TD-CDMA), and CDMA2000), Orthogonal Frequency Division Multiplexing (OFDM) and it variants, General Packet Radio Service (GPRS), Enhanced Data rates for GSM Evolution (EDGE), any other second (2G), third (3G), or fourth (4G) mobile technology, Bluetooth, and Infrared (IrDA). The wireless transceivers 410-412 transmit data to the display device 402 through the wireless communication links 416. In some embodiments, the display device also transmits data to the wireless transceivers 410-412 through the wireless transceiver 414. Although each user 406-408 is shown in FIG. 4 as directly connecting to the display device 402, in at least some embodiments, the connection is indirectly created through other devices, such as a connection through multiple nodes on the Internet.

The radiation shield 404 blocks configurable types of electromagnetic radiation to ensure that the display device 402 receives wireless signals from the users 406-408 and not from users who are not trying to interact, use, and/or view the display device 402. The radiation shield 404 may comprise ceramic, conductive, or any other material that absorbs, eliminates, shields, or deflects electromagnetic radiation. As shown in FIG. 4, the radiation shield 404 may effectively block electromagnetic radiation emanating from behind the display device 402, thereby permitting the wireless transceiver 404 to receive electromagnetic radiation only from users that are roughly in front of the display device 402. Such users would presumably be viewing content on the display device 402. Although shown in FIG. 4 as blocking radiation emanating from the rear of the display device 402, the radiation shield 404 may be placed in any location or configuration that shields the wireless transceiver 414 from a desired type or location of electromagnetic radiation. In addition, in at least some embodiments the radiation shield 404 is integrated into the display device 402 and/or the wireless transceiver 414.

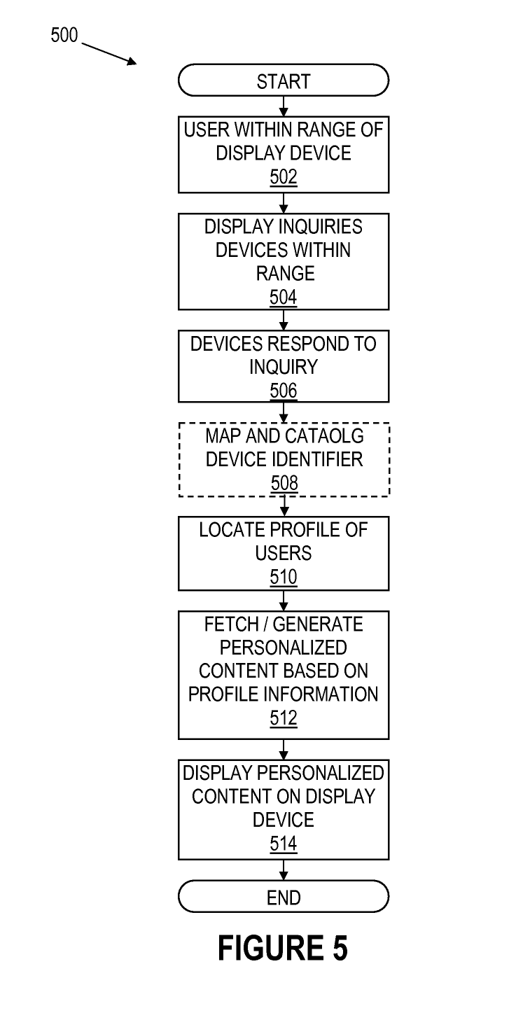

FIG. 5 illustrates a flow chart for an exemplary method 500 of displaying personalized content on a display device in accordance with embodiments of the invention. The method 500 begins when a user that possesses a wireless transceiver comes within range of a display device (502). This range is preferably defined by the effective range of the wireless transceiver coupled to the display and the wireless transceiver of the user. For example, if the display device contains a class 2 Bluetooth transceiver, a user's Bluetooth transceiver may be detected within a range of approximately 10 meters from the display device. When a user is within range, the wireless transceiver coupled to the display device discovers devices within range through an inquiry procedure (504). Typically, any device that is discoverable within the range of the transceiver will respond to the inquiry procedure with one or more identifiers, such as a device identifier, a vendor identifier (VID), a product identifier (PID), a universally unique identifier (UUID), or a combination thereof (506). For example, a user could possess a cell phone that has a Bluetooth transceiver embedded and enabled. When the user comes within range of the display device, the display device inquires the cell phone's Bluetooth transceiver and receives one or more identifiers from the cell phone in response to this inquiry. After receiving the one or more identifiers, the display device optionally maps the identifiers to one or more users and catalogs the identifiers, along with a time stamp (508). This optional mapping may be accomplished by querying a database that matches an identifier to an individual user or groups of users. After the optional mapping, a profile database contained within the display device, or coupled externally to the display device, is queried for profile information associated with the mapped user or the received identifier (510). The profile information may comprise any data associated with mapped user or identifier, such as name, address, gender, height, weight, hobbies, and personal preferences. The display device then fetches or generates personalized content, based in part, on the profile information (512). The method 500 ends when the personalized content is displayed on the display device (514).

As can be appreciated by one of skill in the art, the foregoing method enables the automatic detection of users and the automatic generation of personalized content on a display device in real-time. In practice, the display device may detect a user even before the user is capable of viewing the display device. For example, a user may be detected via a Bluetooth enabled wireless device contained on the user's person at a range of 10 meters. Steps 504-514 may be performed in real-time, allowing personalized content to be displayed before the user is within visual proximity of the display device. Thus, the display device may generate personalized content, such as focused advertisements and news, before the user is even capable of viewing the display device so as to create a more personalized viewing experience. Although Bluetooth is utilized to illustrate the method 500, any wireless communication protocol may be used as desired, such as infrared, Wi-Fi, WiMax, and GSM.

In some embodiments, the display device is also capable of determining the interval of time a user spends within the range of the display device. For example, steps 502-506 may be performed iteratively or in parallel, allowing for the detection and the determination of an interval in which one or more users is within range of the display device. This interval may correlate to the amount of time a user observed the display device. Based on this interval, a user's preferences may be inferred by observing the user's response to the content displayed on the display device. For example, if a particular user is detected within range of the display for an interval of three minutes, and the display device was displaying a sports show or commercial during the three minutes, it may be inferred that the user is interested in sports related content. Thus, the display device, or a system coupled to the display device, may correlate the content displayed on the display device with the interval of time a user remains within the range of the display device. Such a process allows the display to identify preferences of the user through the conduct of the user. The display device therefore learns information about users' preferences and habits over time and can dynamically customize the content of the display based, at least in part, on these preferences and habits. As can be appreciated by one skilled in the art, this information may be the basis for many data mining applications that optimize the generation and display of content on the display device. Various embodiments of the invention perform such data mining operations based, at least in part, on the information inferred from a user's physical proximity to the display device and the interval of this proximity.

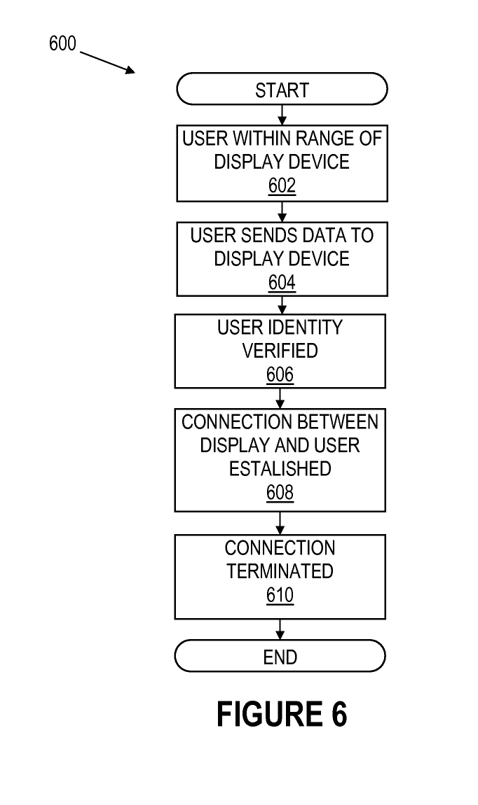

FIG. 6 illustrates a flow chart for an exemplary method 600 of wirelessly connecting a user to a display device in accordance with embodiments of the invention. The method 600 begins when a user comes within proximity of a display device (602). This range is defined by the effective range of the wireless transceiver coupled to the display. For example, if the display device is coupled to an infrared transceiver, the user would be detected roughly within a range of 1 meter from the display. When a user is within range, a wireless transceiver coupled to the user transmits data to the display device (604). Typically, this data will comprise a unique identifier, such as a device identifier, a vendor identifier (VID), a product identifier (PID), a universally unique identifier (UUID), or a combination thereof. For example, a user could possess a cell phone that has Bluetooth enabled. When the user comes within range of the display device, the cell phone's Bluetooth transceiver, which is in service discovery mode, transmits a unique infrared identifier to the display device. The display device then verifies the identity of the user preferably based, at least in part, on the unique identifier (606). This verification may take place at the display device or externally to the display device, such as on a verification server coupled to the display device via the Internet.

After verification is complete, a wireless connection is established between the display device and the user's wireless transceiver (608). This connection may comprise any type of wireless connection, such as Wi-Fi, WiMAX, GSM, and infrared. In some embodiments, the connection is a Bluetooth connection employing one or more various Bluetooth profiles, such as Advanced Audio Distribution Profile (A2DP), Audio/Video Control Transport Protocol (AVCTP), Audio/Video Distribution Transport Protocol (AVDTP), AudioNideo Remote Control Profile (AVRCP), Basic Imaging Profile (BIP), Basic Printing Profile (BPP), Bluetooth Network Encapsulation Protocol (BNEP), Common ISDN Access Profile (CIP), Cordless Telephony Profile (CTP),Dial-up Networking Profile (DUN), Extended Service Discovery Profile (ESDP), Fax Profile (FAX), File Transfer Profile (FTP), Generic Access Profile (GAP), General AudioNideo Distribution Profile (GAVDP), Generic Object Exchange Profile (GOEP), Hands-Free Profile (HFP), Hard Copy Cable Replacement Profile (HCRP), Headset Profile (HSP), Human Interface Device Profile (HID), Intercom Profile (ICP), Object Exchange (OBEX), Object Push Profile (OPP), Personal Area Networking Profile (PAN), Service Discovery Protocol (SDP), Service Discovery Application Profile (SDAP), SIM Access Profile (SAP), Serial Port Profile (SPP), Synchronization Profile (SYNC), Telephony Control Specification (TCS-Binary or TCP), Video Distribution Profile (VDP), and WAP Over Bluetooth Profile (WAP). The method 600 ends when the wireless connection is terminated (610).

In some embodiments, a wireless connection may be established between the display device and the user to eliminate or reduce noise pollution. For example, by streaming audio through a wireless channel after the display device verifies the identifier of the user's wireless transceiver, audio may be streamed without a conventional speaker system. In addition, this audio may be streamed to a plurality of users simultaneously via a one-to-many mode of operation. These embodiments facilitate the hands free transmission of both audio and video to one or more users in proximity of the display device.

As can be appreciated by one of ordinary skill in the art, the methods 500 and 600 enable an interactive experience between one or more users and a display device without any direct contact between the display device and the users. The connection could be used to transfer information, such as coupons related to advertisements displayed on the display device, media, such as an audio or video, and any other type of information related to the content on the display device or a request sent by the user.

In at least some embodiments, a user may interact with a display device through a messaging service, such as short message service (SMS), Multimedia Messaging Service (MMS), or the Internet. In these embodiments, the user sends information through the service either directly to the display device or to a server coupled to the display device but external to it. For example, a user may use a cell phone to send a text message via SMS to a number identified on the display device. The text message may comprise a request for personalized content that is received and handled by the external server before being displayed on the display device. As can be appreciated by one of skill in the art, the external server may be connected to the Internet and may have a vast amount of content readily accessible. Such content may comprise driving or walking directions, maps, local transit schedules, news, sports, weather, restaurant reviews and menus, or any other type of dynamic or static content related to the user's request. In addition, various types of voting systems may be implemented. For example, the display device may display a ballot and users may respond to the ballot via a direct-recording electronic (DRE) voting scheme. After voting, an electronic receipt, signed by the voting authority using digital signatures, may be created and transmitted wirelessly to the user's wireless device via the transport mechanisms previously discussed. In some embodiments, the display device has internal logic designed to receive and process votes from users. In these embodiments, the display device may act as a polling station, tallying responses submitted by users to any type of question displayed on the display device. For example, a display device may list the candidates to the popular American Idol television show. Users in proximity to the display device may vote for the contestant they desire by transmitting a wireless signal to the display device indicating their selected contestant. The display device may periodically, or in a real-time fashion, route responses to a central server, or alternatively may directly tally the responses and directly display the results. The display device preferable has logic that records or generates a unique identifier associated with the wireless device used to cast a vote, or the user casting the vote, to reduce voter fraud and/or multiple votes from a single user.

In at least some embodiments, the methods 500 and 600 facilitate video conferencing using voice over Internet Protocol (VoIP), video teleconferencing (VTC) over ISDN, public switched telephone networks (PSTN), or any other protocol for transmitting real-time audio and video signal between users. In these embodiments, the display devices act as access points for videoconferencing session between users. Thus, utilizing the techniques described herein, a user may approach a display device, may place a call using a wireless transceiver, and may use the audio and/or video features of the display during a videoconferencing session. Because the display devices have relatively large screens, e.g., 15 inches or larger, the display devices facilitate video conferencing for mobile users who generally possess only small displays. In some embodiments, audio is broadcast over standard networks, such as the cellular network, while video is broadcast via the display device's Internet connection. In essence, the display devices in these embodiments acts as public videoconferencing terminals and leverage technical advantages associated with the display device, such as large screen size and a fast network connection, to facilitate videoconferencing.

In other embodiments, the methods 500 and 600 facilitate the purchasing of items representing products and/or services. In these embodiments, a viewer of the display may see a products or service that the viewer desires to purchase. The viewer's cell phone, or other wireless device, may communicate with the display device to complete a transaction, thereby purchasing the product or service on behalf of the viewer. For example, utilizing the techniques described herein, a display device may be configured for virtual window shopping. The display device may show various products and services being offered for sale. If a viewer desires to purchase the offered products or services, the viewer may use a wireless device to transmit billing and/or shipping information to the display device, as well as an optional product identifier that uniquely identifies the product the viewer is purchasing. After transmitting this information, the viewer is billed and the product is preferably shipped to the shipping address provided. In at least some embodiments, the system may automatically infer which product or service the use desires to purchase based on the time the user completes the transaction. For example, if a user submits billing information to a particular display device at 9:15 AM on Sep. 10, 2006, and the only product or service being offered for sale at that time is a Rolex watch, the system may infer that the user desires to purchase the watch.

As can be appreciated by one skilled in the art, the viewer's wireless device may be configured to exchange billing and/or shipping information by installing logic in the form of an application on the device. This application may also control the device's wireless interfaces. For example, a small application may be installed on a user's cellular phone. The application may control and configure the phone's Bluetooth interface to enable communication with a display device. The application may provide a graphical user interface (GUI) for the viewer to purchase the products or services being offered on the display device.

In at least some embodiments, a user may provide the billing and/or shipping information prior to virtual windows shopping. In these embodiments, the information is preferably stored in a database and associated with the user's wireless device via the device's unique identifier, such as a such as a device identifier, a vendor identifier (VID), a product identifier (PID), a universally unique identifier (UUID), or a combination thereof. In these embodiments, the user may simply select the product or service without having to transmit billing or shipping information during each transaction because the information has already been obtained from the user in advance. Thus, these embodiments enable viewers of the display device to directly and seamlessly purchase products being offered for sale on the display in a mobile environment without the need to transfer billing and/or shipping information for each transaction.

In accordance with other embodiments, the display device may be coupled to or integrated with a point of sale (POS) system. For example, the display device may list a menu of items being offered for sale. Users not wanting to purchase a product on the menu via traditional means, such as waiting in line and interacting with a customer service representative, may view the menu on the display device and use their wireless device to checkout. An exemplary implementation may entail integrating the methods 500 and/or 600 into a coffee shop's POS system. The coffee shop may have a plurality of offerings representing drinks and food items available for purchase. Each offering may be listed on the display device in a menu format with identifiers uniquely identifying each offering and a purchase price. Viewers of the display may purchase the item by utilizing the product identifier and their wireless device. For example, a large decaffeinated coffee may be assigned the identifier “117” and may cost $2.99. A viewer may enter this identifier into the viewer's wireless device and purchase the item without having to wait in line. The order is then routed to the coffee store's POS system where clerks at the store fulfill the order. When the order is ready for pick up, the display device may indicate that the order is ready by displaying the purchaser's name, an order identifier, or any other type of information associated with the transaction. Alternatively, the integrated POS system may send a wireless message, for example by SMS, to the purchaser indicating the order is ready. As can be appreciated by one of ordinary skill on the art, the foregoing system and method enables users who perceive the display device to seamlessly purchase products and/or services in a mobile environment without resorting to traditional purchasing options, such as waiting in line for a customer service representative. The user may place an order and return to pick up the order if desired. Billing and ordering are processed automatically by the integrated POS system using one or more of the methods described herein.

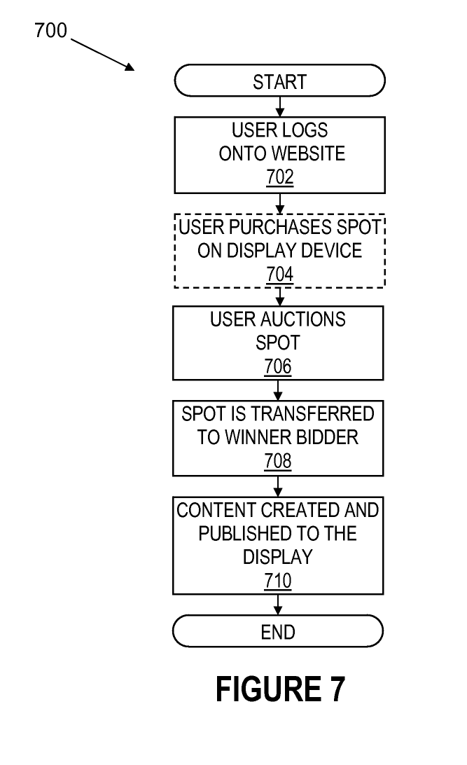

FIG. 7 illustrates a flow chart for an exemplary method 700 for trading and auctioning spots on a network of display devices in accordance with embodiments of the invention. The method 700 begins when a user logs onto an auction-based website (702). Once logged onto the website, the user may optionally purchase “spots” on a network of display devices (704). For example, a user may be an advertiser wishing to place an advertisement on one or more display devices in the network. The advertiser may purchase a thirty second spot that permits the advertiser to place an advertising campaign on one or more display devices in the network during a specified time period. After the user purchases the spot, the user may auction the spot via an electronic auctioning system (706). Other users may bid on the auctioned spot until the auction ends, at which time a user wins the auction for the particular spot and ownership of the spot is transferred to the winner (708). The method 700 ends when the winning user creates, publishes, and schedules content to the appropriate display during the spot won (710). This step also preferably occurs online through a graphical user interface. As can be appreciated by one of skill in the art, the foregoing method permits users to purchase, sell, auction, and trade spots on a network of display devices. Although thirty seconds is given as an example of a typical spot, in practice the spots may comprise any duration of time. In some embodiments, spots are defined by geography, by time, by affiliation, or any other metric used by the network to segment content.

Although the steps for methods 500, 600, and 700 are given in a predefined order, the steps may be similarly performed out of order if desired. In addition, some steps may be added or dismissed from the foregoing exemplary methods when desirable. For example, if multiple users are in range of the display device, the display device or a server external to the display, but coupled to it, may use an algorithm to determine which personalized content to display. For example, if twenty users are viewing the display and a majority of these users have a preference for Italian food, directions to an Italian restaurant along with recent reviews of the restaurant and its current menu and pricing may be displayed. The algorithm itself is preferably dynamic in nature, actively monitoring when users enter and leave the effective range of a given display, or a predefined range stored in storage coupled to the display. In addition, when multiple display devices are networked together, the network may exploit knowledge of the device's physical location to extrapolate which users may be in range of a particular display device at a given time and display personalized content as necessary. For example, if a user leaves the range of a first display device, a signal may be sent to neighboring display devices indicating that the user is near these neighboring displays and provide an expected time for the user's arrival. These neighboring displays may pre-fetch personalized content and either display such content in expectation of the user or cache such content so that when the user is within range, the content does not need to be fetched or a profile associated with the user does not need to be ascertained. In addition, after a user schedules content, the content may be filtered to remove unwanted material, such as profanity and nudity. This filtering process is preferably automatic by using a list of known words that are to be filtered out of textual content. The filter may also uses various method of imaging and signal processing to ascertain, identify, and eliminated unwanted visual elements in pictures, video, and other graphical content.

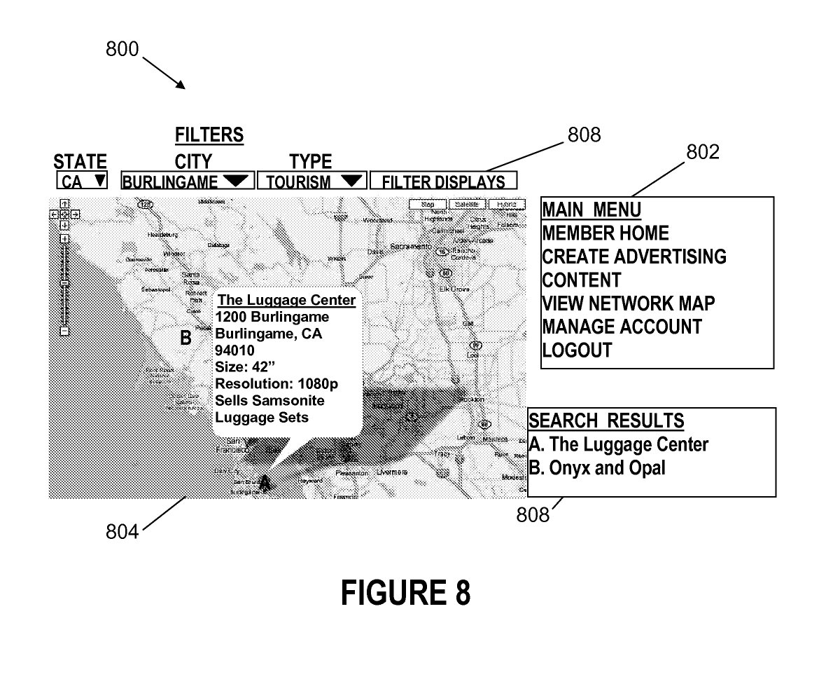

FIG. 8 depicts an exemplary visualization system for viewing and publishing content to a network of display devices. As shown in FIG. 8, the visualization system 800 comprises a menu area 802, a map area 804, one or more filters 806, and a search results area 808. The menu area 802 allows users to perform operations generally associated with on online account based system, such as logoff and manage their account settings, as well as operations linked to the map area 804, such as publish content to a display whose locations is shown on the map area 804. The map area 804 preferably shows the locations of one or more displays that comprise a network of displays. Information associated with a particular display within the network may also be shown in the map area 804. This information may comprise the resolution of the display, the exact address of the display, the size of the display, the type of display, e.g., LCD, plasma, LED, and any other information associated with the display or the area surrounding the display, such as analytic and/or demographic information. The analytic information may comprise population by gender, race/ethnicity, age, income, trends in populations and any other characteristic associated with a display or the people surrounding a display. In addition, this information may be targeted by providing a specific radius from the display. For example, the map area 804 may show demographic information for individuals within a two mile radius of a particular display in the network.

In at least some embodiments, the visualization system 800 contains the filters 806 with which a user may input criteria about a display and search the network of displays based on the criteria. For example, a user may input a brand of product, such as Coca-Cola. Based on this criterion, a search may be performed to identify displays positioned in stores that sell, or are otherwise associated with, Coca-Cola. The results of the search may be displayed in the search result area 808. Although a search based on products was used in the example above, a user may search based on any other metric associated with a display, such as geographic location, type of establishment that is associated with the display, physical size of display, availability of advertising spots on the display, pricing of advertising spots on the display, and details describing users who previously advertised on the display.

In some embodiments, the visualization system 800 shows a snapshot of the current content displayed on one or more selected displays. For example, when a user selects a particular display, a snapshot of the display is dynamically created and shown to the user in real-time. This process enables the user to see exactly the content that is currently being displayed on the display, and allows the user to make a better decision as whether to advertise on that particular display.

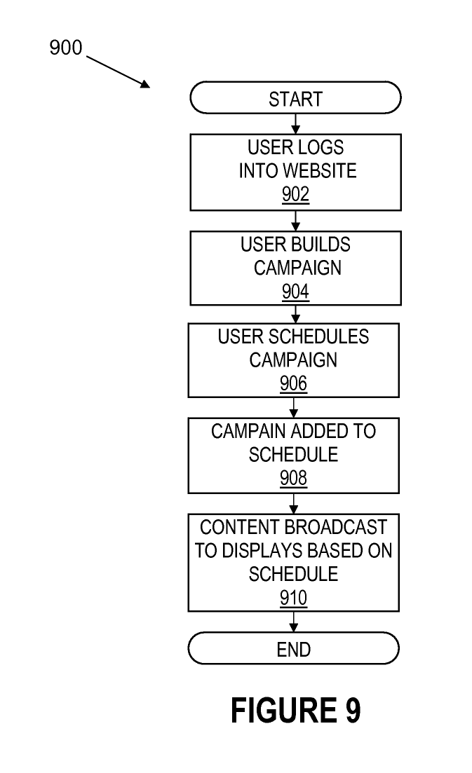

FIG. 9 illustrates a flow chart for an exemplary process 900 for scheduling and broadcasting content to a network of display devices. The method 900 begins when a user logs onto a website (902). The user then builds an advertising campaign by generating, uploading, or linking content, such as audio, video, images, HTML, blogs, and wikis, that the user desires to be broadcasted on a network of displays (904). The building is preferably accomplished through the use of a digital media creation tool that is located online, but may alternatively be distributed to users as a stand alone software application. The digital media creation tools facilitates the creation and remixing of various types of media content, such as image, videos, websites, blogs, and wikis. Preferably an image library is also linked to the digital media creation tool to ease the creation of content for users. After building the content, the user then schedules the campaign by selecting a time, location, and/or duration for the campaign (906). The process 900 ends when the user's selections are added to a schedule that display devices query to determine what content to display at what time on which display and which segmented section of the display device (908).

The scheduling functionality provided in process 900 is preferably implemented by creating one or more tables in a flat file, relational database, or multidimensional database. For example, step 908 may be implemented by issuing an SQL statement to a database that adds a record to one or more tables. The record preferably comprises the following information:

Schedule

| Trans_id | start_time | end_time | Devicemask | section | Path | duration |
|---|---|---|---|---|---|---|
| 1 | 2007-01-10 | 2007-03-10 | 105 | corporate | www.mydomain.com/1.swf | 30 |
| | 10:30:00 | 11:30:00 | | | | |

where trans_id is the primary key of the schedule table, start_time and end_time are timestamps representing the start and end time of the campaign, devicemask is a masked representation of which displays to display the campaign, section is the segmented section of a display to display the campaign, path is a local or remote resource identifier, and duration is the length of time to display the campaign. The exemplary data provided represents a thirty second advertising campaign located at http://www.mydomain.com/1.swf (a remotely hosted Flash video file) scheduled to start at Jan. 10, 2007 at 10:30 AM and to conclude at Mar. 10, 2007 at 11:30 AM. The campaign will be displayed on all displays matching the device mask “105______”, where an underscore represents any single character variable. Thus, if the prefix “105” is associated with the state Massachusetts, the mask “105______” would match all displays physically located in the state of Massachusetts. The exemplary campaign will also be displayed in the corporate section of each display for thirty seconds. As can be appreciated by one of ordinary skill in the art, scheduling content through the preceding method facilitates the creation of a list of paths and durations through the execution of a single SQL statement based on a device identifier and the current time. In addition, this implementation facilitates the cycling of content because the duration of the advertisement is known. Preferably the content identified by the path is prefetched and cached before being displayed to increase performance. In other embodiments, user campaigns are stored on a server remote to the network of displays and compressed. In these embodiments, each display periodically grabs content comprising a plurality of campaigns that are formatted to reduce size. Various types of compression and archive techniques may be used, such as ZIP, ZIP64, Universal Image Format, GZIP, TAR, TAR with GZIP, LHA, ALZ, and DMG.

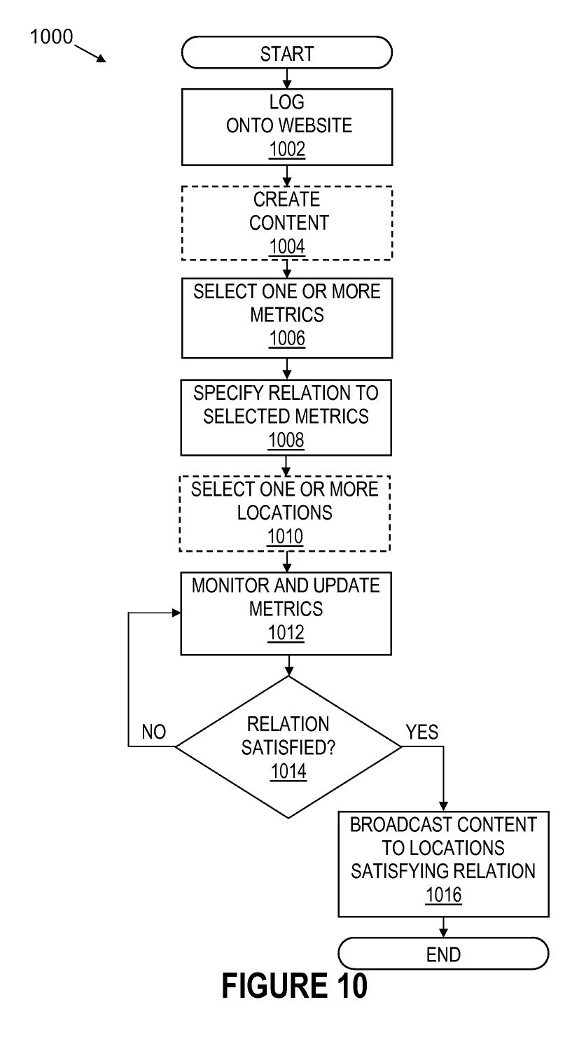

FIG. 10 depicts an illustrative method for dynamically distributing content bases on one or more metrics in accordance with embodiments of the invention. The process 1000 starts when a user preferably logs onto a website designed to facilitate interaction with the user (1002). The website may be implemented with various web based technologies, such as Javascript, ActionScript, Dynamic HTML (DHTML), PHP, Perl, ASP or ASP.NET, Ruby on Rails, and JSP. After a user logs in, the user optionally creates content (1004). As previously discussed, the user may create content by uploading the content, referencing the content from another website, using an online editor, or any other mean of associating content with the user. The content may comprise graphical content, video content, audio content, or any other type of content, such as advertising content. Instead of creating content, the user may also use preexisting content, such as content the user utilized in previous advertising campaign or content found in a content repository, such as Google Images and YouTube.

After optionally creating the content, the user then selects one or more metrics (1006). These metrics represent any measurable type of information associated with a place, such as temperature, humidity, average gas prices, interest rates, unemployment rate, population, racial makeup, average age, and any other measurable type of information describing a place. After a user selects one or more of these metrics, the user may specify a relation to the selected metrics (1008). For example, if a user selects gas prices and temperature, the user may specify a relation using these metrics. For example, the relation may indicate that the user's content should be distributed when the average gas price associated with a location is at or above 1.5 times the national average and the temperature is above 70 degree Fahrenheit. As can be appreciated, virtually any relationship may be created using the metrics, such as linear, quadratic, arithmetic, exponential, and inverse relationships.

After defining the relation, the user optionally selects one or more locations associated with the relation (1010). The locations may include any place, such as districts within cities, cities themselves, states, regions, countries, continents, and any other classification of a land mass or subset of a land mass no matter how small. The locations selected indicate places the user desires to broadcast the content, optionally created in step 1004, when the relation of step 1008 is satisfied. For example, using the relation defined above and a selected location of San Francisco, Calif., indicates that the content should be distributed to San Francisco when the average gas price in San Francisco is at or above 1.5 times the national average and the temperature is above 70 degree Fahrenheit. If the user does not select a location, all possible locations may be used. In the example above, not selecting a location would indicate that the content should be distributed to all places where the average gas price is at or above 1.5 times the national average and the temperature is above 70 degree Fahrenheit.

The system implementing the method 1000 preferably is responsible for monitoring the metrics (1012). For example, a computer system may be configured to monitor various data sources that are accessible through the Internet. These data sources may be maintained by the system or a third party. For example, one data source may represent the National Weather Service's database on current temperatures. Another data source may represent the Bureau of Labor Statistics database on employment information across the United States. The system is preferably configured to monitor these data sources to obtain accurate metrics. The monitoring may be active or passive. In embodiments employing active monitoring, the data sources are periodically queried to ascertain if any information related to the metrics has been updated. In embodiments employing passive monitoring, the data source itself sends updates, preferably on a defined schedule, such as hourly, daily, weekly, or monthly. Thus, with active monitoring the system initiates the request, while with passive monitoring, the system waits until the data sources provide an update. In at least some embodiments, the data source are RSS feeds describing the metrics, such as a weather RSS feed from The Weather Channel, a stock ticker from Bloomberg, and a sports score feed from ESPN. The relation is periodically or continuously checked against the data sources (1014). If the relation is not satisfied, the method continues to monitor the metrics (1012) until the relation is satisfied for a particular place. When the relation is satisfied, the content is broadcast to those locations satisfying the relation (1016) and the process ends.

Numerous steps may be added, remove, or reordered in the methods 900 and 1000 as desired. For example, after broadcasting the content to location that satisfies the relation, the method 1000 may continue to monitor the metrics until the relation is no longer satisfied for a particular region. When the relation is no longer satisfied, a signal may be sent over a portion of a network of display devices physically located in the region. Such a signal may trigger a display device to stop displaying the associated content. Additionally, the user may specify a start and end date for the monitoring (step 1012). Specifying a start and end date may further enhance the flexibility of the method and provide the user with even more control over the distribution of content.

The above discussion is meant to be illustrative of the principles and various embodiments of the present invention. Numerous variations and modifications will become apparent to those skilled in the art once the above disclosure is fully appreciated. For example, users may specify a maximum amount of money they desire to spend on their advertising campaign. The system may continue to distribute content based on the chosen metrics and formulated relation until the funds associated with the campaign are depleted. It is intended that the following claims be interpreted to embrace all such variations and modifications.

What is claimed is:

1. A display device, comprising:
a processor that decodes visual content;
a wireless interface that communicates with a wireless device associated with a viewer of the display device; and
logic configured to receive information from the wireless device and purchase an item depicted on the display device for the viewer.

2. The display device of claim 1 wherein the wireless device comprises a cellular phone and the wireless interface comprises a bluetooth interface.

3. The display device of claim 1 wherein the logic is further configured to segment the display device into a plurality of sections and each section shows an item that may be purchased by a viewer of the display device.

4. The display device of claim 1 wherein the logic is further configured to display the visual content at a predetermined time and in one of a plurality of display segments.

5. The display device of claim 1 further comprising a second wireless interface that receives the visual content from an external source.

6. The display device of claim 1 further comprising a clock that determines how long the wireless device is in range of the display device.

7. The display device of claim 1 further comprising storage that caches the visual content before the visual content is displayed on the display device.

8. A method, comprising:
receiving a request to broadcast content based, at least in part, on one or more variable metrics;
monitoring a plurality of data sources that contain information related to the one or more variable metrics; and
distributing the content to locations satisfying a relation utilizing the one or more variable metrics.

9. The method of claim 8 further comprising receiving a timeframe and broadcasting the content to locations satisfying the relation during the timeframe.

10. The method of claim 8 wherein monitoring a plurality of data sources comprises sending a request to the data sources and receiving updates from the data sources.

11. The method of claim 8 further comprising removing the content from locations that no longer satisfy the one or more variable metrics.

12. The method of claim 8 further comprising caching the content in storage located at the locations satisfying the one or more variable metrics.

13. The method of claim 8 further comprising displaying the content at the locations satisfying the one or more variable metrics on a display that is internally mounted in a storefront window.

14. A network, comprising:
a plurality of displays, each display comprising a wireless interface configured to communicate with viewers of the display;
one or more centralized servers that couple to the plurality of displays and that distribute visual content to the plurality of displays; and
logic that couples to one or more centralized servers and that controls when the visual content is distributed to the plurality of displays.

15. The network of claim 14 wherein the wireless interface is further configured to purchase products for the viewers of the display.

16. The network of claim 14 wherein the plurality of displays are physically positioned in a store window so as to be seen from outside of the store.

17. The network of claim 14 wherein the plurality of displays comprise a peripheral selected from the group consisting of a microphone, barcode reader, tachometer, visible light sensor, heat sensor, and camera.

18. The network of claim 14 wherein the plurality of displays are divided into a plurality of sections, each section displaying visual content that is independent of visual content displayed in any other section.

19. The network of claim 18 wherein the logic further controls which of the plurality of sections the visual content is to be displayed.

20. The network of claim 18 wherein at least one of the plurality of sections displays live informational content.
